(19) United States
(12) Patent Application Publication
(10) Pub. No.: US 2024/0335982 A1
(43) Pub. Date: Oct. 10, 2024

(54) MOLD WITH VARIOTHERM MOLD TEMPERATURE STRUCTURE

(71) Applicant: RAYSPERT PRECISION INDUSTRIAL INC, Tainan (TW)

(72) Inventors: Shun-Fu Lin, Tainan (TW); Chun-Jen Chen, Tainan (TW)

(21) Appl. No.: 18/195,947

(22) Filed: May 11, 2023

(30) Foreign Application Priority Data
Apr. 6, 2023 (TW) 112112797

(51) Int. Cl. B29C 33/04; B29C 33/38

(52) U.S. Cl. CPC B29C 33/046; B29C 33/3842; B33Y 80/00

(57) ABSTRACT

Provided is a mold with a variotherm mold temperature structure, including a based body, a heating device and an air control device. A mold cavity and a hot runner are provided inside the base body. The inside of the hot runner is filled with a working fluid, and the temperature and circulation of the working fluid are maintained by the heating device. A cold gas runner is provided between the hot runner and the mold cavity, and a plurality of brackets are arranged inside the cold gas runner. The air control device is communicated with one end of the cold gas runner, and can inject medium and low temperature gas from one end of the cold gas runner such that the medium and low temperature gas exchanges temperature with the base body.

### BACKGROUND OF THE INVENTION

### 1. Field of the Invention

The present disclosure relates to a mold, and particularly relates to a mold structure that can quickly change the mold surface temperature and shorten the production cycle.

### 2. The Prior Arts

First of all, plastic injection molding is mainly to use granular plastic raw materials. The plastic material is heated by the injection molding machine until it becomes a flowing liquid, and the mold is heated by the hot water system of the mold such that the plastic material flows well during the injection process and can fill the mold cavity. Subsequently, the plastic colloid is injected into the mold through pressure, and the mold is opened after cooling to complete the plastic product. The production time of injection molding focuses on the temperature change of the mold, which is related to the quality of the surface of the plastic product. For general injection molding molds, in order not to affect the fluidity of raw materials, the mold usually needs to be kept at a high temperature of 50 degrees to 250 degrees. After the plastic raw material is injected into the mold cavity, the mold usually becomes hotter and hotter. While the mold is waiting to be cooled, it must be switched to a cooling state to cool the finished product so as to avoid deformation of the finished product and reduce production time to save energy.

Please refer to FIG. 1, in the existing mold 1 with variotherm mold temperature, the control of the temperature change is mainly to arrange a waterway 11 inside the mold, and a temperature exchange device 12 is arranged outside the mold 1 to connect with the waterway 11. The temperature exchange device 12 has a circulation pipeline 121, a heater 122, a diversion pipeline 123 and a refrigerator 124. Two ends of the circulation pipeline 121 are respectively connected to the inlet 111 and the outlet 112 of the waterway 11. The heater 122 is arranged on the path of the circulation pipeline 121. FIG. 1 represents the diversion pipeline 123 with dashed line path. A first controller 125 and a second controller 126 are respectively provided at both ends of the diversion pipeline 123. The first controller 125 is arranged in the circulation pipeline 121 between the outlet 112 of the waterway 11 and the heater 122. The second controller 126 is arranged in the circulation pipeline 121 between the heater 122 and the inlet 111 of the waterway 11. The refrigerator 124 is arranged in the diversion pipeline 123 between the first controller 125 and the second controller 126. A fluid circulates inside the waterway 11 and the temperature exchange device 12.

As such, the fluid in the mold 1 is heated by the heater 122 such that the fluid sequentially passes through the circulation pipeline 121, the inlet 111 of the waterway 11, the outlet 112 of the waterway 11 and the heater 122. At this time, the first controller 125 and the second controller 126 close the communication of the diversion pipeline 123 such that the fluid is guided to flow through the heater 122. The heat of the fluid is transferred to the mold 1 by using the property of metal conduction temperature such that the mold cavity 13 on the surface of the mold 1 can reach a predetermined temperature.

When the injection of the plastic raw material to fill the mold cavity is completed and the mold need to be cooled, the first controller 125 and the second controller 126 open the communication of the diversion pipeline 123 and close the circulation pipeline 121 to the heater 122, thereby allowing the high-temperature fluid flows from the outlet 112 of the waterway 11 to the diversion pipeline 123, the refrigerator 124, the circulation pipeline 121 and the inlet of the waterway 11 in sequence. The fluid is cooled by the refrigerator 124 such that the temperature of the mold 1 is cooled by the low-temperature fluid, and at the same time, the effect of cooling the injection product is achieved.

However, since the mold 1 needs rapid heating and rapid cooling, it is very energy-consuming to change the fluid between high temperature and low temperature with the heater 122 and refrigerator 124 in a short period of time. In addition, the rapid thermal expansion and contraction of the waterway 11 with the temperature change of the fluid causes the metal to be easily fatigued, and the problem of structural cracking is likely to occur at the joints or turns of the waterway 11. Moreover, the distance from the waterway 11 to the surface of the mold 1 is not consistent. As such, when the temperature at the short distance d1 reaches the predetermined temperature, the manufacturing process must wait for the temperature to be transmitted to the long distance d2 such that the production cycle of the finished product under this structure will be relatively long.

### SUMMARY OF THE INVENTION

In view of the shortcomings and deficiencies of the prior art, the main objective of the present disclosure is to improve the problems of energy consumption and time consumption caused by the existing structure.

In order to achieve the above-mentioned objective, the technical means adopted in the present disclosure is a mold with a variotherm mold temperature structure, which mainly includes: a base body, a heating device and an air control device.

The base body having a molding surface. The molding surface has at least one mold cavity. a hot runner with a predetermined path is provided inside the base body. The inside of the hot runner is filled with a working fluid, and a cold gas runner is provided between the hot runner inside the base body and the mold cavity. The cold gas runner is an irregular path connected by a plurality of heat accumulation reference points in the base body by mold flow analysis, and a plurality of brackets are arranged inside the cold gas runner.

The heating device is located outside the base body and communicates with both ends of the hot runner through a circulation pipeline. The working fluid is maintained at a predetermined temperature by the heating device and circuits in the hot runner and the circulation pipeline in one direction

The air control device communicated with one end of the cold gas runner. The air control device injects medium and low temperature gas from one end of the cold gas runner, and discharges the base body from the other end of the cold gas runner such that the medium and low temperature gas exchange temperature with the base body.

In one embodiment, each of the brackets is arranged in the cold gas runner in one of three-dimensional staggered, spaced, dislocated manners, or a combination thereof.

In one embodiment, the base body, the hot runner, the cold gas runner and the brackets are integrally made by three-dimensional printing.

In one embodiment, part of predetermined areas of the base body is integrated with different materials for three-dimensional printing according to requirements.

In one embodiment, each of the brackets is integrated with different materials for three-dimensional printing according to requirements.

In one embodiment, the base body is provided with a low density area at the heat accumulation reference point, a plurality of runner branches is provided inside the low density area, and two ends of each runner branch are respectively connected to the cold gas runner and the mold cavity.

In one embodiment, the heating device has a temperature sensor to detect a temperature of the working fluid.

In one embodiment, the base body is one of a male mold, a female mold and a mold core in the mold.

Through the aforesaid structure, the heat source and cold source required in the molding process are arranged in different paths such that the heat source of the working fluid in the hot runner can be transferred to the mold cavity through each bracket and the mold cavity reaches the predetermined molding temperature. When the plastic is filled into the mold cavity and waits for cooling, the air control device injects medium and low temperature gas into the cold gas runner adjacent to the mold cavity such that the medium and low temperature can quickly reach thermal equilibrium with the high temperature of the mold cavity, thereby shortening the cooling time of the finished product, solving the problem of energy consumption and shortening the production cycle of the finished product at the same time.

### BRIEF DESCRIPTION OF THE DRAWINGS

FIG. 1 is a schematic diagram showing the prior art.

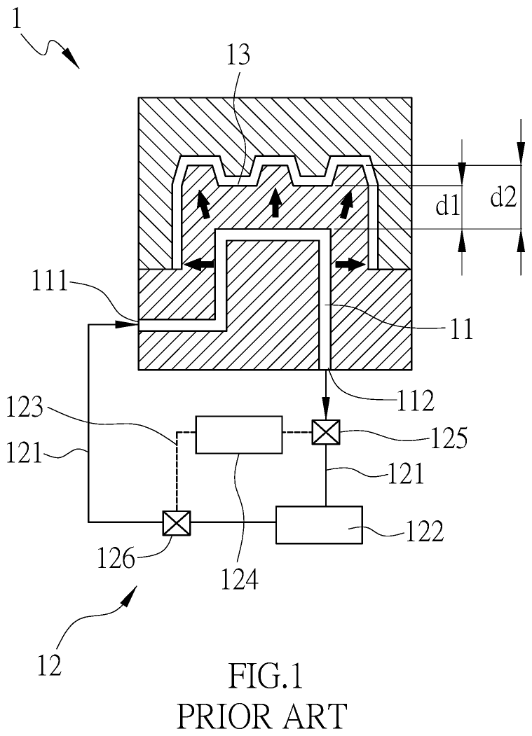

FIG. 2 is a schematic diagram showing a mold structure of the present disclosure.

FIG. 3 is a schematic plan view showing a cold gas runner and brackets according to the present disclosure.

FIG. 4 is a schematic cross-sectional diagram showing the cold gas runner of the present disclosure.

FIG. 5 is a schematic diagram showing an embodiment of the present disclosure.

FIG. 6 is a three-dimensional schematic diagram showing the cold gas runner of the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

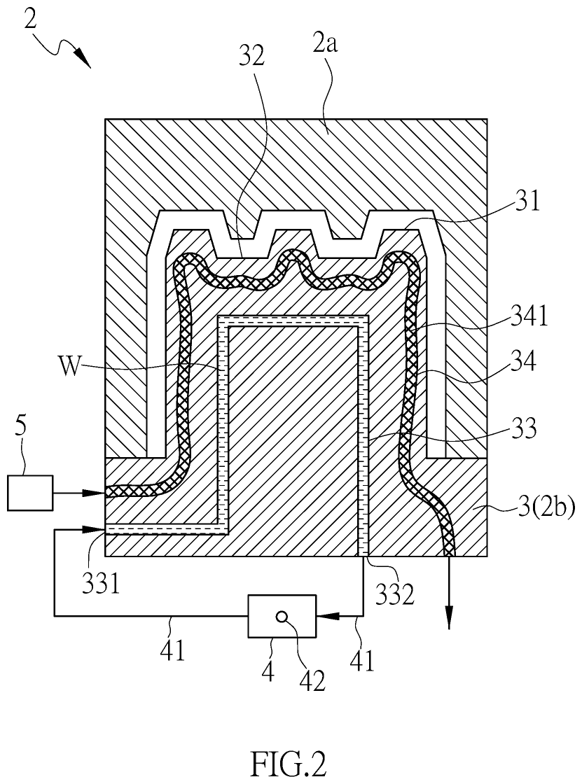

Please refer to FIG. 2, which shows a mold 2 with a variotherm mold temperature structure according to a preferred embodiment of the present disclosure. The mold 2 mainly includes a base body 3, a heating device 4 and an air control device 5. The base body 3 may be the upper mold 2a or the lower mold 2b in the mold 2. Alternatively, the base body 3 may be a mold core (not shown) embedded in the upper mold 2a or the lower mold 2b. FIGS. 2, 5 and 6 show that the base body 3 is the lower mold 2b in the mold 2 as an example for illustration. In addition, there are other functional structures in the mold 2, which are not shown in the drawings because they are not within the scope of the present disclosure.

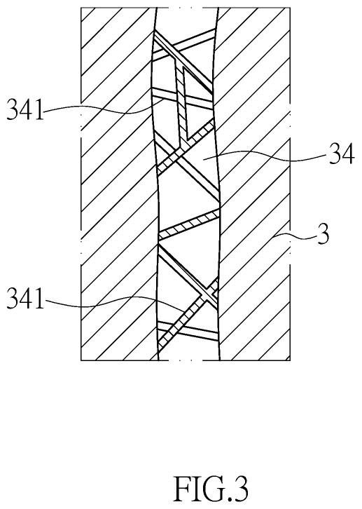

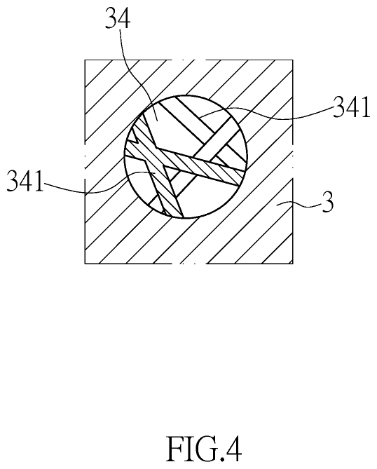

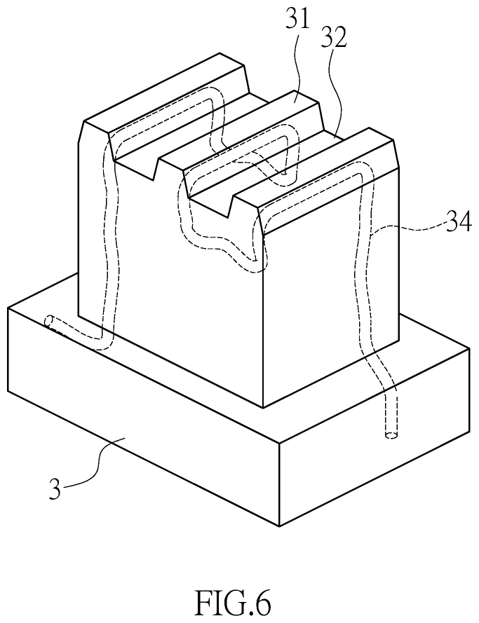

In this embodiment, the base body 3 has a molding surface 31, and the molding surface 31 has at least one mold cavity 32. The base body 3 has a hot runner 33 inside the mold cavity 32. The path of the hot runner 33 is provided according to the shape of the finished product and the data obtained by mold flow analysis. Accordingly, the hot runner 33 in FIG. 2 is only a schematic diagram, and is not intended to limit its path. The inside of the hot runner 33 is filled with a working fluid W, and the working fluid W is liquid. In addition, a cold gas runner 34 is provided between the hot runner 33 and the mold cavity 32 inside the base body 3. The position of the cold gas runner 34 is obtained through mold flow analysis, and the plurality of heat accumulation reference points in the base body 3 are obtained by reverse deduction according to empirical judgments. Additionally, the cold gas runner 34 is an irregular path connected by the plurality of heat accumulation reference points. The cold gas runner 34 is adjacent to the mold cavity 32 and has a predetermined distance from the hot runner 33. The illustration of this embodiment is only a schematic plane illustration. The actual implementation of the hot runner 33 and the cold gas runner 34 is shown in FIG. 6. A three-dimensional irregular path is formed according to the shape of the mold cavity 32 and the plurality of heat accumulation reference points. Moreover, a plurality of brackets 341 are arranged inside the cold gas runner 34. The plurality of brackets 341 in FIG. 2 are represented by a mesh, and the mesh is not used to limit the structural shape of each of the brackets 341. As shown in FIGS. 3 and 4, each of the brackets 341 is mainly arranged in the cold gas runner 34 in one of three-dimensional staggered, spaced, dislocated manners, or a combination thereof so as to improve the structural support strength of the cold gas runner 34 and provide a path for conducting the heat source of the hot runner 33 to the mold cavity 32.

The heating device 4 is arranged outside the base body 2, and the heating device 4 communicates with the inlet 331 and outlet 332 at both ends of the hot runner through a circulation pipeline 41. The working fluid W is maintained at a predetermined temperature by the heating device 4, and the working fluid W is driven to circulate unidirectionally in the hot runner 33 and the circulation pipeline 41, thereby allowing its heat source to conduct to the mold cavity 32 through the metal. The heating device 4 has a temperature sensor 42. The temperature sensor 42 is mainly used to detect the temperature of the working fluid W. When the temperature of the working fluid W drops to a predetermined limit value, the heating device 4 will be activated to heat the working fluid W. When heating to the predetermined temperature, the heating device 4 will be automatically turned off or will lower the heating temperature.

The air control device 5 communicates with one end of the cold gas runner 34. The air control device 5 can inject medium and low temperature gas from one end of the cold gas runner 34, and operatively discharge the base body 3 from the other end of the cold gas runner 34 such that the medium and low temperature gas is allowed to exchange temperature with the base body 3, thereby reducing the temperature of the mold cavity 32.

When the mold 2 starts to enter the production process, the air control device 5 is in a closed state, and the heating device 4 is turned on to heat the working fluid W, and conducts the heat source to the surface of the mold cavity 32 through the circulation of the working fluid W and the characteristics of metal conduction. Since the arrangement of the cold gas runner 34 will block local heat conduction, the heat source of the working fluid W will be transferred to the surface of the mold cavity 32 through each of the brackets 341 to reach a predetermined injection molding temperature.

After the plastic is injected, the air control device 5 can be turned on without turning off the heating device 4. The air control device 5 continuously injects the medium and low temperature gas into the cold gas runner 34, discharges the gas from the other end to the outside of the base body 3, and conducts the medium and low temperature gas to the surface of the mold cavity through the brackets. Consequently, the conducted medium and low temperature gas can quickly exchange temperature with the mold cavity to achieve heat balance, and the finished product (not shown) in the mold cavity 32 can be rapidly cooled, thereby shortening the production cycle.

Further, while the mold cavity 32 is cooling, the cold gas runner 34 also has the effect of blocking the heat source conduction of the working fluid W, which keeps the surroundings of the hot runner 33 in a state of high temperature. When the mold 2 starts the subsequent production process, it is not necessary to heat the working fluid W from a low temperature to a predetermined high temperature as in the prior art, thereby reducing energy consumption and having environmental protection benefits. In addition, the present disclosure does not limit the temperature of the medium and low temperature gas. The preferred medium and low temperature range is −5° C.˜70° C. The medium and low temperature gas injected by the air control device 5 can be adjusted according to the temperature change inside the mold cavity 32. Alternatively, the medium and low temperature gas with a fixed temperature can be injected to gradually reach the predetermined temperature.

It is worth mentioning that the base body 3, the hot runner 33, the cold gas runner 34 and the brackets of the present disclosure are integrally made by three-dimensional printing. In order to allow the temperature of the hot runner 33 and the cold gas runner 34 to have a better conduction effect, part of the predetermined areas of the base body 3 can be integrally made by three-dimensional printing with different materials according to requirements, for example, the combination of copper and steel. That is to say, the base body 3 has areas of two or more different materials. Additionally, the present disclosure is not limited to the material of the base body 3, which may be metal or non-metal, but is preferably made of metal material with good thermal conductivity. Moreover, each of the brackets 341 is mainly used as a heat source for conducting the hot runner 33 and as a support for the cold gas runner 34. As such, each of the brackets 341 can be integrated with the same material as the base body 3 for three-dimensional printing. Alternatively, the brackets 341 and the base body 3 may be integrally made by three-dimensional printing according to the requirements and different materials. For example, ⅔ of the brackets is made of copper, and other ⅓ of the brackets 341 is made of steel. Copper has excellent temperature conductivity and ductility. Hence, the heat source of the hot runner 33 can be quickly transferred to the mold cavity 32, and it can also withstand changes in thermal expansion and contraction, but the hardness of copper is relatively low. Therefore, part of the brackets 341 is made of steel, which can make up for the supporting strength of copper. Alternatively, copper can be mixed with other metals to increase its hardness, and each of brackets 341 is arranged in a staggered, spaced or dislocated manner, as shown in FIGS. 3 and 4. The cold gas runner 34 can be well supported, thereby avoiding the problem of collapse of the cold gas runner 34 adjacent to the mold cavity 32 when subjected to molding pressure. However, the above are only illustrative embodiment. The material collocation of each of the brackets 341 and the distribution of the quantity of each of the brackets may vary according to the structural design of the mold 2.

Herein, the present disclosure improves the problems of metal fatigue and mold cracking caused by thermal expansion and contraction by splitting the heat source and the cold source to the hot runner 33 and the cold gas runner 34. The working fluid W does not need rapid high and low temperature changes, thereby reducing energy consumption. Further, since the cold gas runner 34 is adjacent to the mold cavity, the medium and low temperature can be quickly conducted to the mold cavity 32. While waiting for cooling, the cold gas runner 34 also blocks the heat source conducted by the hot runner 33 such that the mold cavity 32 and the finished product can shorten the cooling time, thereby shortening the production cycle.

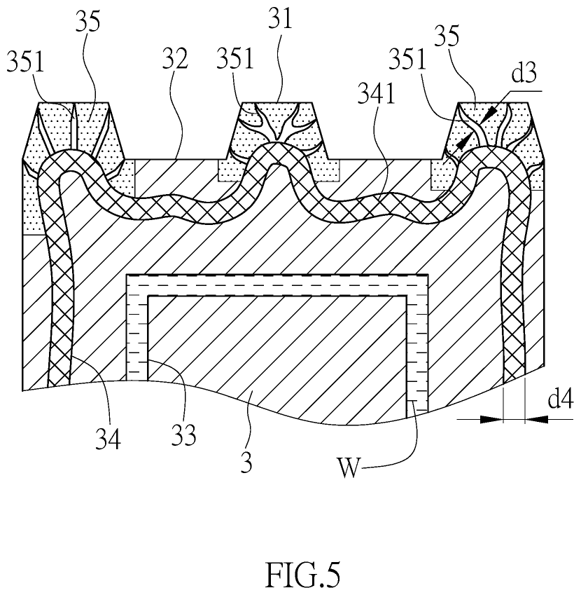

Please continue with FIG. 5, which shows an embodiment of the present disclosure according to the above structural changes. Accordingly, the same structure will not be repeated, and only the differences in structure will be described below. In this embodiment, the base body 3 is provided with the low density areas 35. The low density areas 35 are arranged at the heat accumulation reference points or the areas where the finished product is not easy to demould due to reverse deduction base on empirical judgments. The low density areas 35 are located within the mold cavity 32, and are integrally formed with the base body 3 by three-dimensional printing. The low density areas 35 of the present disclosure is sintered with low density materials by three-dimensional printing such that each of the low density areas 35 has a plurality of micropores that can be connected. FIG. 5 represents micropores with dot shape, and the line segments at the junctions of the low density area 35 and other areas of the base body 3 only represent the ranges of the low density areas 35, and are not used to limit the shapes of the low density areas 35. The drawing of this embodiment has multiple low density areas 35. Each of the ow density areas 35 is provided with a plurality of runner branches 351. Two ends of each of the runner branches 351 are respectively connected to the cold gas runner 34 and the mold cavity 31. Each of the runner branches 351 is also communicated with the micropores of the low density areas 35. If the low density areas 35 overlap with the cold gas runner as shown in FIG. 5, each of the micropores can also communicate with the cold gas runner 34.

As mentioned above, the width d3 of each runner branch 351 is smaller than the width d4 of the cold gas runner 34, and each of the runner branches 351 is located at one end of the mold cavity 32 and is tapered. In this way, the medium and low temperature gas in the cold gas runner 34 will achieve the effect of pressurized ejection from the large pipe diameter into the small pipe diameter, and can achieve an auxiliary role in the demoulding process. In addition, the present disclosure does not limit the path and shape of each of the runner branches 351. The path and shape of each of the runner branches 351 are obtained by reverse deduction according to the heat accumulation reference points or based on empirical judgments. Each of the runner branches 351 shown in FIG. 5 is only a schematic illustration.

Accordingly, when the production process comes to the cooling stage, the medium and low temperature gas in the cold gas runner 34 can diffuse through the runner branches and enter the mold cavity 32 through the micropores, thereby allowing the mold cavity 32 to shorten cooling time more. When the medium and low temperature gas diffuses into the mold cavity 32 through the micropores, the surface of the finished product can be separated from the surface of the mold cavity 32 such that the finished product will not have mucous membrane problems, thereby reducing the defect rate caused by demoulding deformation.

To sum up, the mold with the variotherm mold temperature structure of the present disclosure has the following advantages through the configuration of the hot runner 33 and the cold gas runner 34:
1. Through the arrangement of high and low temperature split flow, the working fluid W does not need to change between rapid cooling and rapid heating, thereby saving energy consumption and having great economic and environmental benefits.
2. By arranging the cold gas runner 34, the production cycle is shortened and production capacity is increased.
3. The metal fatigue problem caused by the thermal expansion and contraction effect is improved.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A mold with a variotherm mold temperature structure, comprising:
a base body having a molding surface, wherein the molding surface has at least one mold cavity, a hot runner with a predetermined path is provided inside the base body, an inside of the hot runner is filled with a working fluid, a cold gas runner is provided between the hot runner inside the base body and the mold cavity, the cold gas runner is an irregular path connected by a plurality of heat accumulation reference points in the base body by mold flow analysis, and a plurality of brackets are arranged inside the cold gas runner;
a heating device located outside the base body and communicating with both ends of the hot runner through a circulation pipeline, wherein the working fluid is maintained at a predetermined temperature by the heating device and circuits in the hot runner and the circulation pipeline in one direction; and
an air control device communicated with one end of the cold gas runner, wherein the air control device injects medium and low temperature gas from one end of the cold gas runner, and discharges the base body from the other end of the cold gas runner such that the medium and low temperature gas exchange temperature with the base body.

2. The mold with the variotherm mold temperature structure of claim 1, wherein each of the brackets is arranged in the cold gas runner in one of three-dimensional staggered, spaced, dislocated manners, or a combination thereof.

3. The mold with the variotherm mold temperature structure of claim 1, wherein the base body, the hot runner, the cold gas runner and the brackets are integrally made by three-dimensional printing.

4. The mold with the variotherm mold temperature structure of claim 3, wherein part of predetermined areas of the base body is integrated with different materials for three-dimensional printing according to requirements.

5. The mold with the variotherm mold temperature structure of claim 3, wherein each of the brackets is integrated with different materials for three-dimensional printing according to requirements.

6. The mold with the variotherm mold temperature structure of claim 1, wherein the base body is provided with a low density area at the heat accumulation reference point, a plurality of runner branches is provided inside the low density area, and two ends of each runner branch are respectively connected to the cold gas runner and the mold cavity.

7. The mold with the variotherm mold temperature structure of claim 6, wherein the low density area is located in the mold cavity.

8. The mold with the variotherm mold temperature structure of claim 1, wherein the heating device has a temperature sensor to detect a temperature of the working fluid.

9. The mold with the variotherm mold temperature structure of claim 1, wherein the base body is one of a male mold, a female mold and a mold core in the mold.
